(19) United States
(12) Patent Application Publication
(10) Pub. No.: US 2007/0207338 A1
(43) Pub. Date: Sep. 6, 2007

(54) X-ray target and method for manufacturing same

(75) Inventors: Timothy N. McKechnie, Brownsboro, AL (US); Anatoliy Shchetkovskiy, Owens Cross Roads, AL (US); Alexander B. Smirnov, Huntsville, AL (US)

Correspondence Address: LANIER FORD SHAVER & PAYNE P.C., P O BOX 2087, HUNTSVILLE, AL, 35804, US

(73) Assignee: Plasma Processes, Inc., Huntsville, AL (US)

(21) Appl. No.: 11/364,922

(22) Filed: Mar. 1, 2006

(51) Int. Cl. C25D 3/54; C25D 3/56; B32B 15/00

(52) U.S. Cl. 428/661; 205/238; 205/262; 428/665

(57) ABSTRACT

A method for fabricating and the resulting x-ray target comprising metal deposited on an electrically-conductive base member by electrodeposition from a molten salt electrolyte is claimed. The method comprises submerging the base member in a molten salt electrolyte bath. The base member acts as a cathode and anodes of target material metals are activated by electrical circuitry to deposit a target layer onto the base member. The electrodeposition method results in an exceptionally dense and pure layer of tungsten or tungsten alloy. Target materials of tungsten, tungsten alloy, rhenium, and rhenium alloy produce good results when electrodeposited onto base members fabricated from molybdenum, molybdenum alloy, and graphite-or carbon-based composites.

### BACKGROUND OF THE INVENTION

The invention relates to a method of manufacturing an x-ray target for x-ray tubes, in which a target layer of tungsten, tungsten alloy, rhenium or rhenium alloy is electrodeposited upon a support member in a molten salt electrolyte bath. The invention also relates to the x-ray target obtained by means of said method.

X-ray tubes produce x-ray photons by accelerating a stream of electrons and colliding them into a target. In some x-ray generation technologies, electrons are first released from a heated, incandescent filament, and then a high voltage between an anode and a cathode accelerates the electrons and causes them to impinge upon the anode. The anode, which is also used in other types of x-ray generation technologies, is often a rotating disc type known as a rotary anode or x-ray target. The ring-shaped area of the target's surface onto which the electrons impinge is called the focal track or focal path.

Refractory metals with a high specific heat and good thermal conductivity, particularly molybdenum, are often used as base materials for the x-ray target. In the area of the focal track, a tungsten or tungsten-alloy layer is usually applied over the base material.

Several U.S. Patents have disclosed and claimed rotary anodes manufactured of molybdenum/tungsten combinations. For example, U.S. Pat. No. 4,534,993 discloses a method for the production of and a rotary anode made of a molybdenum support member onto which a target layer of tungsten is deposited by a plasma spraying method. Similarly, U.S. Pat. No. 6,289,080 discloses and claims a molybdenum rotary anode in which the tungsten target track is manufactured by a process of “tape casting, slip casting, roll compaction, slurry spraying, thermal spraying or waterfall processing” (Col 6 lines 47-49) to produce a track/target substrate.

None of the prior art rotary anodes or processes, however, have employed electrodeposition in a molten salt electrolyte to deposit the tungsten or tungsten alloys onto the base molybdenum. Indeed, the density and purity of the tungsten layer that results from previously-known methods such as thermal spraying could be improved by employing an atomic-level deposition technique such as electrodeposition. It would also be desirable to reduce the oxygen and carbon content that tends to weaken the tungsten layer.

Further, powdered tungsten required for thermal spraying can be expensive. It would be desirable to employ a process for depositing the tungsten focal track that primarily uses tungsten in a less expensive bulk or even scrap form.

In addition, thermal spraying of tungsten or tungsten alloys generally requires very high processing temperatures (e.g. >1000° C.) in order to achieve the best possible density and purity in the resultant layer. High temperatures during thermal spray deposition can damage the molybdenum base member by causing the molybdenum to recrystallize. It would be desirable to have a tungsten deposition technique for x-ray targets in which processing temperatures are generally less than about 1000° C. while still achieving high density and purity of the tungsten or tungsten alloy layer.

Further, it would be desirable to improve the adhesion between the target layer and the base member of the x-ray target.

### SUMMARY OF THE INVENTION

The present invention achieves these objectives by providing an x-ray target fabricated by depositing metal onto an electrically-conductive base member using electrodeposition from molten salt electrolyte. The electrodeposition process results in a target layer of exceptional purity, density, and adhesion.

Using the new method, the target layer is deposited by electrodeposition from molten salt electrolyte. The target layer may be comprised of metals such as tungsten, tungsten rhenium, tungsten alloy, tungsten carbide, rhenium, or rhenium alloy. The base member may be fabricated of any electrically-conductive material, and good results have been achieved with molybdenum, molybdenum alloy, graphite and carbon-based composites. The electrolyte is a mixture of salts containing electrochemically active species of tungsten, rhenium and/or alloying constituents in a concentration typically from about 0.5% to about 25% weight.

During the electrodeposition process, the support member is a cathode and material to be deposited is an anode or anodes. The temperature of the molten salt mixture generally varies from about 700° to about 1100° C. The electrodeposition is performed in an electrolyzer under inert atmosphere such as argon. A dense, non porous tungsten target layer can be obtained with cathodic current density from about 0.001 A/cm² to about 0.50 A/cm². The density of electrodeposited tungsten is close to theoretical maximum density. The target layer generally has a thickness of between about 0.2 and about 2.0 millimeters, though other thicknesses are possible.

The x-ray target layer obtained by electrodeposition from molten salt has good adhesion to the support member, in part because the thin film of oxide that usually exists on the surface of the support member is dissolved in the molten salts during initial preheating of the support member in electrolyte.

Another advantage of manufacturing the x-ray target layer by electrodeposition from molten salt is relatively low temperature of processing (i.e. can be below 900° C.), which prevents recrystallization of the molybdenum or molybdenum alloy support member and any resulting reduction of its strength.

Electrodeposited tungsten typically has a purity of about 99.9%. Very low oxygen and carbon content (typically less than about 50 ppm) provide excellent grain cohesion in the tungsten coating and reduces the ability for cracking under electron bombardment.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

These and other embodiments of the present invention will also become readily apparent to those skilled in the art from the following detailed description of the embodiments having reference to the attached figures, the invention not being limited to any particular embodiment(s) disclosed.

### DESCRIPTION OF THE DRAWINGS

FIG. 1 is a cross sectional view of a rotary anode according to the present invention.

FIG. 2 is an illustration of the electrodeposition process.

Repeat use of reference characters throughout the present specification and appended drawings is intended to represent the same or analogous features or elements of the invention.

### DETAILED DESCRIPTION

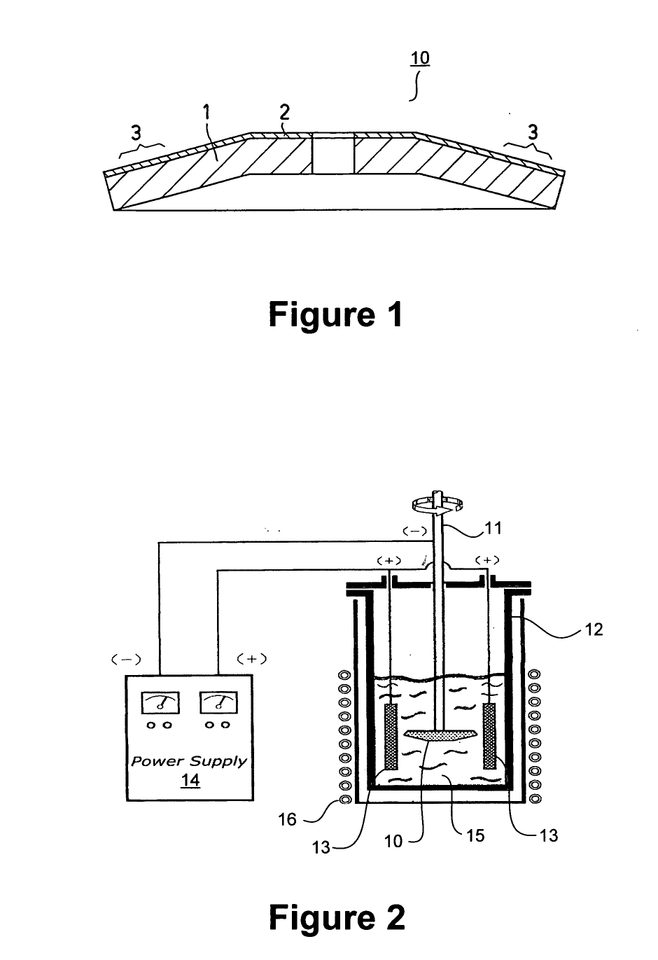

FIG. 1 shows a rotary anode 10 constructed from a supporting member 1 and a target layer 2. The portion of the target layer indicated by 3 is the place onto which the electron beam in the x-ray tube is focused (focal path 3 ). In this illustrated embodiment, the target layer is shown as deposited over the entire surface of the target. In other embodiments of the invention, the target layer is deposited only in the focal path 3, usually a ring-shaped area, by masking off the areas that are not in the focal path.

The support member 1 may be fabricated from any electrically conductive material. Good results have been achieved using support members fabricated from molybdenum, molybdenum alloy, and graphite or carbon-based composites. Particularly suitable is a cast or sintered alloy consisting of 0.40-0.60% by weight of Ti, 0.05-0.12% by weight of Zr and 0.01-0.05% by weight of C, remainder Mo; an alloy comprising 5% by weight of W, remainder Mo, and molybdenum which contains 0.25-1.50% by weight of Y₂O₃.

One or more further layers may be present between the target layer and the basic member 1, for example, a layer of pure tungsten and the like. The target layer 2 consists of a such as tungsten, tungsten alloy, rhenium, or rhenium alloy. All alloys known for this purpose are suitable. Particularly good results have been obtained with tungsten-rhenium alloys (up to 10% by weight of rhenium).

The surface of the target layer, except for the focal path 3, and/or of the basic member, may be roughened to improve the thermal radiation or for the same purpose it may be lined with thermal radiation-improving materials (for example, a rough tungsten layer or a layer consisting of Al₂O₃ with TiO₂).

It is possible for the target layer to have a composition gradient (for example, of the rhenium content) which varies through the layer thickness.

Manufacturing techniques for the rotary anode base member are well known in the art. Electrodeposited tungsten, tungsten alloy, rhenium, or rhenium alloy may be deposited on all known types of molybdenum or molybdenum alloy rotary anodes and carbon-based anodes.

The setup for the electrodeposition technique is illustrated in FIG. 2. A molten salt electrolyte solution 15 is heated in an electrolyzer 12 at temperatures generally between 700° and 1100° C. The salt electrolyte solution contains electrochemically active species of tungsten, WO₄²⁻, W₂O₇²⁻, WO₃, WF₆⁻, WCl₆²⁻, WCl₆, WOF₆⁻, or WOCl₄⁻. When a tungsten alloy is being deposited, the salt electrolyte solution also contain alloying constituent such as ReCl₄²⁻, ReO₄⁻, or ReF₆⁻. The concentration of the tungsten plus alloying constituents (if used) is from about 0.5% to 25% by weight. For the salt portion of the solution, any of a number of salt electrolyte solutions will produce the desired results. One typical molten salt electrolyte is a mixture of potassium chloride (KCl), sodium chloride (NaCl) and tungsten hexachloride (WCl₆). Another typical molten salt electrolyte uses sodium tungstenate (Na₂WO₄) and tungsten trioxide (WO₃).

The unplated support member 10 is placed on a rotatable shaft 11 and submerged solution 15. The gas in the electrolyzer is an inert gas, such as argon, at atmospheric pressure. The shaft 11 is connected to a power supply 14. Target layer material 13 connected to the power supply acts as the anode for the electrodeposition process and the support member is the cathode. Under a cathodic current density from 0.001 A/cm² to 0.50 A/cm, a highly dense, non-porous target layer can be obtained. The rate of deposition is dependent on current density and is typically 5-50 micrometers per hour.

A target layer of tungsten-rhenium alloy can be obtained by electrodeposition from molten salt containing tungsten and rhenium species. Separate anodes of tungsten and rhenium are used. The separate electrical circuits for tungsten and rhenium anodes allow electrodeposition of tungsten-rhenium alloys with rhenium concentration from 0.05% to 30%. For carbon-based support members, rhenium and tungsten/rhenium focal paths are electrodeposited using the same method as that for molybdenum support members. When using carbon-based support members, it is common to deposit a layer of pure rhenium directly on the carbon before depositing a tungsten or tungsten/rhenium target layer, in order to prevent formation of a carbide layer.

After termination of the electrodeposition process, the support member plus target layer is removed from the molten salt electrolyte mixture and allowed to cool in the inert gas in the electrolyzer. The resulting product is finally removed from the chamber and further processed, the focal path 3 (FIG. 1) then being ground. The target layer generally has a thickness after grinding of between 0.2 and 2.0 millimeters, though other thicknesses are possible.

By means of the method according to the invention a density of more then 99% of the theoretical maximum density, and up to 99.9%, was obtained in all the above tungsten alloys. Moreover, the adhesion of the target layer to the support member was improved.

Table 1 below contains actual trace element analysis results for the impurities within a sample tungsten layer (Sample No. 050000051, Sample ID 1-121804) applied in accordance with the method disclosed herein. The sample tungsten layer was 99.9% pure.

TABLE 1
Impurities in Sample Tungsten Target Layer

| Element | PPM |
|---|---|
| Ag | <0.1 |
| Al | <0.1 |
| As | <0.5 |
| Au | <0.4 |
| B | <0.1 |
| Ba | <0.1 |
| Be | <0.1 |
| Bi | <0.1 |
| C | 32.6 |
| Ca | <0.1 |
| Cd | <0.1 |
| Ce | <0.1 |
| Cl | 35.8 |
| Co | <0.1 |
| Cr | <0.1 |
| Cu | <0.1 |
| Fe | <0.1 |
| Ga | <0.1 |
| Ge | <0.3 |
| I | <0.1 |
| In | <0.1 |
| Ir | 2.14 |
| K | 4.61 |
| La | 0.63 |
| Li | <0.1 |
| Mg | <0.1 |
| Mn | <0.1 |
| Mo | 29.5 |
| N | <0.1 |
| Na | <0.1 |
| Ni | 3.76 |
| O | 0.86 |
| Os | <0.2 |
| P | <0.1 |
| Pb | <0.1 |
| Pd | <0.1 |
| Pt | 0.26 |
| Rh | <0.1 |
| Ru | <0.1 |
| S | 1.94 |
| Sb | <0.1 |
| Se | <0.1 |
| Si | <0.1 |
| Sn | <0.1 |
| Te | <0.1 |
| Ti | <0.1 |
| Tl | <0.1 |
| V | <0.1 |
| Zn | <0.1 |
| Zr | <0.1 |

As described above and shown in the associated drawings, the present invention comprises an x-ray target and the associated method for manufacture. While particular embodiments of the invention have been described, it will be understood, however, that the invention is not limited thereto, since modifications may be made by those skilled in the art, particularly in light of the foregoing teachings. It is, therefore, contemplated by the appended claimed to cover any such modifications that incorporate those features or those improvements that embody the spirit and scope of the present invention.

What is claimed is:

1. A method of electro-depositing a target layer of a metal onto an x-ray target support member, the method comprising the steps of:
a. placing the support member in a molten salt electrolyte mixture; and
b. depositing by electrodeposition a metal target layer onto the support member.

2. The method of claim 1, wherein the metal is selected from the group consisting of tungsten, tungsten alloy, rhenium, and rhenium alloy.

3. The method of claim 1, wherein the molten salt electrolyte mixture comprises at least one electrochemically active species of tungsten selected from the group consisting of WO₄²⁻, W₂O ₇²⁻, W0₃ , WF₆₋, WCl₆²⁻, WCl₆⁻, WCl₆, WOF₆ ⁻and WOCI₄⁻.

4. The method of claim 2, wherein the molten salt electrolyte mixture further comprises at least one alloying constituent selected from the group consisting of ReCl₄²⁻, ReO₄⁻, and ReF₆⁻.

5. The method of claim 1, wherein the molten salt electrolyte mixture comprises potassium chloride, sodium chloride, and tungsten hexachloride.

6. The method of claim 1, wherein the molten salt electrolyte mixture comprises sodium tungstenate and tungsten trioxide.

7. The method of claim 1, wherein the molten salt electrolyte mixture comprises chloride electrolytes.

8. The method of claim 1, wherein the molten salt electrolyte mixture comprises fluoride electrolytes.

9. The method of claim 1, wherein the molten salt electrolyte mixture comprises oxide electrolytes.

10. The method of claim 1, wherein the resulting target layer has a density at least equal to 99% of its theoretical maximum density.

11. The method of claim 1, wherein the resulting target layer has a purity of about 99%.

12. The method of claim 1, wherein the resulting target layer has a thickness of between about 0.2 and about 2.0 millimeters.

13. The method of claim 1, further comprising the step of:
c. rotating the support member during the electrodeposition process.

14. The method of claim 1, wherein the molten salt electrolyte mixture is maintained at a temperature between about 700° C. and about 1100° C. during the electrodeposition process.

15. The method of claim 1, wherein the target support member is comprised of any electrically-conductive material.

16. The method of claim 1, wherein the target support member is comprised of an electrically-conductive material selected from the group consisting of molybdenum, molybdenum alloy, graphite and carbon-based composite material.

17. The method of claim 1, wherein said target layer consists essentially of tungsten alloyed with from about 0.05% to about 30% by weight of rhenium.

18. An x-ray target comprising:
an electrically-conductive base member; and
an electrodeposited target layer.

19. The x-ray target of claim 18, wherein the target layer is selected from the group consisting of tungsten, tungsten alloy, rhenium, and rhenium alloy.

20. The x-ray target of claim 18, wherein the base member is selected from the group consisting of molybdenum, molybdenum alloy, graphite and carbon-based composite material.

21. The x-ray target of claim 18, wherein the target layer has a density at least equal to about 99% of its theoretical maximum density.

22. The x-ray target of claim 18, wherein the target layer has a thickness from about 0.2 to about 2.0 millimeters.

23. The x-ray target of claim 18, wherein the target layer has a purity of about 99%.

24. The x-ray target of claim 18, wherein the target layer comprises tungsten alloyed with from about 0.05% to about 30% by weight of rhenium.

25. The x-ray target of claim 18, further comprising an electrodeposited rhenium or rhenium alloy layer between the target layer and the base member.

26. An x-ray target made by the process of claim 1.
